(19) United States
(12) Patent Application Publication
(10) Pub. No.: US 2026/0127669 A1
(43) Pub. Date: May 7, 2026

(54) SYSTEMS AND METHODS USING EDGE ARTIFICIAL INTELLIGENCE COMPUTING DEVICES AND SYSTEMS FOR FACILITATING A DECENTRALIZED EXCHANGE OF CRYPTOASSETS

(71) Applicant: Michael B. ROHLFS, Northbrook, IL (US)

(72) Inventor: Michael B. ROHLFS, Northbrook, IL (US)

(21) Appl. No.: 19/375,853

(22) Filed: Oct. 31, 2025

Related U.S. Application Data
(60) Provisional application No. 63/717,618, filed on Nov. 7, 2024.

(51) Int. Cl. G06Q 40/04; G06Q 20/36; G06Q 20/38; H04L 9/00; H04L 9/32

(52) U.S. Cl. CPC G06Q 40/0421; G06Q 20/367; G06Q 20/381; G06Q 40/043; H04L 9/3213; H04L 9/50; H04L 2209/463

(57) ABSTRACT

A system for managing and carrying out trading and swaps of spot cryptoasset index tracking weighted asset benchmark prices (SCAITWABPs). The system makes use of a plurality of edge artificial intelligence computing devices (EAICDs) for powering peer-to-peer (P2P) marketplaces. The EAICDs facilitate processor computer driven decentralized exchanges (DEX) of SCAITWABPs whose spot index cryptoasset values track market prices and algorithm-driven performance analytics of referenced weighted average benchmark (WAB) sets of tradable assets, whereby each asset specified in the WAB set qualifies for transactions physically settled over counterpart marketplaces. A plurality of dongles are used with each being independently operably associated with a specific one of said EAICDs. Each one of the EAICDs includes: artificial intelligence (AI); machine learning (ML) and dongle authentication processes. These components advance carrying out decentralized finance with controls over access to price discovery and analytics data streamed to and from a remote hybrid paradigm price discovery database (HPPDD), as well as an electronic, self-custodial wallet and operations pertaining to the electronic, self-custodial wallet.

### CROSS-REFERENCE TO RELATED APPLICATIONS

This application claims the benefit of U.S. Provisional Application No. 63/717,618, filed on Nov. 7, 2024. The entire disclosure of the above application is incorporated herein by reference.

### FIELD

The present disclosure relates to systems and methods for facilitating the trading of financial instruments, and more particularly to systems and methods which make use of edge artificial intelligence computing devices to power a permissionless, peer-to-peer marketplace which facilitates a decentralized exchange of offsetting long and short spot index cryptoasset pairs whose market prices are in each case geared to track those of a referenced Weighted Average Benchmark linked to a specified set of tradable real world assets.

### BACKGROUND

The statements in this section merely provide background information related to the present disclosure and may not constitute prior art.

At the present time there are only limited solutions for Blockchain Oracle Problems (“BOP”), which impact the rapidly evolving and aggressively growing field of Decentralized Finance (“DeFi”). Oracles serve as middleware facilitating communications between on-chain blockchain smart contracts and off chain crypto transaction reporting systems processed for a primary blockchain by a secondary layer or other chain outside of the blockchain for price discovery purposes aimed at speeding up processing times and reducing transaction costs.

For background concerning BOP, it should be noted that blockchain infrastructure does not pull in data from, or push data out to, any external system as built-in functionality. That is because blockchains are designed as isolated networks, akin to a computer sans internet connection. Although that creates some security and reliability in a micro sense, financial smart contracts, like those used in this invention and other crypto markets, need reliable market price information. Facilitating connections between blockchain smart contracts (“on chain”) and the outside (“off-chain”) world for that purpose requires the additional oracle infrastructure.

Oracle-based DEX's are DeFi trading venues typically relying on one or more oracle price discovery feeds to help price assets being exchanged. Market pricing for assets is thus imported from external venues rather than deduced via organic price discovery. Risks exist with that arrangement, such as cases of oracle front-running and price manipulation of assets having low liquidity.

Some BOP are security-based. Some reports have revealed that nearly two-thirds of DeFi hacks in the field are linked to oracle exploitation. Furthermore, even though these types of applications are considered by their users to be decentralized, their oracles use centralized and trusted third parties providing data through unverified and unsecured channels; therefore, calling them “decentralized” is a euphemism that comes with risks.

Accordingly, there is a strong need for a new system and method which reduces BOP risks by providing security at affiliated Hybrid Paradigm Price Discovery Databases (“HPPDD”) used for market price discovery and related analytics data generated for all physical assets referenced by attendant spot index crypto asset pairs listed for P2P DEX trading. And unlike most crypto trades, data for both the short and long sides come from the same affiliated HPPDD. Combining security measures at the HPPDD level with user-authentication controls at the edge artificial intelligence computing device (“EAICD”) level, would guard against BOP risks with a high level of confidence. The latter level would ideally contain the following features: (i) all EAICD users must be authenticated HPPDD subscribers to access and connect with its data feeds; (ii) all electronic, self-custodial wallets employed for DEX transactions, be they internal (i.e., a component of the user's EAICD) or external (i.e., connected to EAICD via authorized dongle), must be disconnected from the internet unless switched on by the EAICD-a security process designed to preclude potentially malicious intrusions; (iii) once the user's EAICD indicates it has received requisite off-chain HPPDD feed and is ready to transact, the electronic, self-custodial wallet is cleared for internet connection culminating in interaction with on-chain smart contracts specified to effectuate desired DEX transactions.

Furthermore, as will be appreciated from the above, at the present time Cryptoassets use cryptography, P2P networks and a distributed ledger technology to create, verify and secure transactions. However, present day systems are limited in their ability to handle DEX trading instruments listable in nascent cryptoasset markets, particularly those targeted by this invention: long and short spot index cryptoasset pairs whose market prices are in each case geared to track those of a referenced Weighted Average Benchmark (“WAB”) linked using algorithm-driven systems and methods to a specified set of real world assets physically tradable over affiliated traditional finance (“TradFi”) platforms on centralized permissioned networks outside of the digital world. Advancing DEX platforms with the use of HPPDD and EAICD would help mitigate attendant BOP risks while empowering peer-to-peer (“P2P”) traders of all types and sizes to gain exposure to substantial global markets without making direct investments in physical assets, asset baskets or exchange traded derivatives (“ETDs”) over centralized TradFi venues. Exchanging offsetting index positions-also known as pairs trading-is a process using algorithms to calculate the respective long and short fractionalized ownership units serving to equalize the extended market values desired for each side of a DEX transaction. Employing DEX pair trading formulas incorporating market price data analytics using powerful and important tools like artificial intelligence (“AI”) and machine learning (“ML”), would enable traders and investors, alike, to devise advanced strategies aimed at capturing a wider range of new market opportunities, adjusting to market volatility in those markets, and hedging their activities.

Pair trading strategies in this case uniquely employ the power of AI and ML in two stages: first, at an HPPDD in the cloud where each listed instrument's market price history and related analytics are compiled for streaming to user-customers with an authenticated EAICD; and next, at the network's edge where an EAICD is able to seamlessly apply the streamed HPPDD information to targeted pairs of DEX trading instruments. The latter stage's processes may also apply the effects of other data customized by users to form strategic models aimed at identifying a range of hypothetical trading risks and rewards attendant to each targeted pair using assumptions such as liquidity, volatility, market sentiment, changes in pair composition, and the timing of contemplated actions.

Likewise, existing financial exchange systems do not yet make meaningful use of AI and ML to incorporate dynamic encryption systems that can be automatically updated to guarantee robust protection, as envisaged by this invention. Furthermore, Al and ML would facilitate the use of algorithms able to analyze vast amounts of data in real time to make attendant systems highly adaptable, intelligent and more able to learn, to evolve and to identify suspicious activities before they escalate into security breaches. Adding AI and ML to dongle authentication hardware and software can also regulate identity and access management, plus detect and predict, anomalous behavior threatening security.

Moreover, there remains a need for a system and method that is uniquely able to enhance liquidity, particularly with regard to cryptoassets, in part by creating cross-liquidity opportunities, that also benefit all types of trading involving physical, real world assets. There further is a need for such a system which can leverage the use of AI and ML, including but not limited to one synergistic with open-source digital twins technology, to create dynamic encryption systems that provide even more robust security and protection to various parties making use of the system. There is also a need for a system as described above, which can apply the systems and methods described in U.S. Pat. No. 11,403,655 to a multitude of asset trading opportunities on centralized and decentralized platforms having addressable market sizes totaling hundreds of trillions of dollars worldwide.

### SUMMARY

This section provides a general summary of the disclosure, and is not a comprehensive disclosure of its full scope or all of its features.

In one aspect the present disclosure relates to systems and methods using edge artificial intelligence computing devices and systems for facilitating a centralized exchange of cryptoassets. In one embodiment the system may include a plurality of edge artificial intelligence (AI) computing devices (EAICDs) for powering peer-to-peer (P2P) marketplaces which facilitates processor or computer driven decentralized exchanges (DEX) of spot index cryptoasset pairs whose values track market prices and algorithm-driven performance analytics of referenced weighted average benchmark (WAB) sets of tradable assets. Each one of the sets of tradable assets specified in the WAB set qualifies for transactions physically settled over counterpart marketplaces. The system may also include a plurality of dongles. Each one of the plurality of dongles is independently operably associated with a specific one of said EAICDs. Each one of the plurality of EAICDs includes an artificial intelligence (AI) module, a machine learning (ML) module, dongle authentication process modules to advance carrying out decentralized finance with controls over access to price discovery and analytics data. The price data and analytics data is streamed to and from a remote hybrid paradigm price discovery database (HPPDD). Each one of the plurality of EAICDs may also include or be securely linked to an electronic self-custodial wallet configured to store operations pertaining to the electronic, self-custodial wallet carried out by at least one of human traders, BOT traders, liquidity providers, trade validators, price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and requisite proof of reserves compilations.

In another aspect the present disclosure relates to a system having a plurality of edge artificial intelligence computing devices (EAICDs) for powering peer-to-peer (P2P) marketplaces. The EAICDs facilitate processor or computer driven decentralized exchanges (DEX) of spot index cryptoasset pairs whose values track market prices and algorithm-driven performance analytics of referenced weighted average benchmark (WAB) sets of tradable assets. Each one of the sets of tradable assets specified in the WAB set qualifies for transactions physically settled over counterpart marketplaces. The system may also include a plurality of dongles, each one of said plurality of dongles being independently operably associated with a specific one of said EAICDs. Each one of the plurality of EAICDs includes an artificial intelligence (AI) module, a machine learning (ML) module, a dongle authentication process modules to enable and/or advance carrying out decentralized finance with controls over at least one of access to price discovery or analytics data streamed to and from a remote hybrid paradigm price discovery database (HPPDD). The system may further include an electronic, self-custodial wallet configured to store operations pertaining to the electronic, self-custodial wallet carried out by at least one of human traders, BOT traders, liquidity providers, trade validators, price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and any requisite proof of reserves compilations. The EAICDs are further configured to incorporate and automatically update dynamic encryption systems aimed at achieving robust protection via the use of algorithms analyzing vast amounts of data in real time to be more adaptable, intelligent, and able to learn, evolve and identify suspicious activities before said suspicious activity escalates into a security breach.

In another aspect the present disclosure relates to a method for managing and carrying out trading and swaps of spot cryptoasset index tracking weighted asset benchmark prices (SCAITWABPs), and wirelessly between remotely located parties or entities. The method may comprise operations including using a plurality of edge artificial intelligence (AI) computing devices (EAICDs) for powering peer-to-peer (P2P) marketplaces to facilitate processor or computer driven decentralized exchanges (DEX) of spot index cryptoasset pairs whose values track market prices and algorithm-driven performance analytics of referenced weighted average benchmark (WAB) sets of tradable assets. Each one of tradable assets specified in the WAB set qualifies for transactions physically settled over counterpart marketplaces. The method may further include using a plurality of dongles. Each one of the plurality of dongles may be independently operably associated with a specific one of the EAICDs. Each one of the plurality of EAICDs includes an artificial intelligence (AI) module, a machine learning (ML) module, and dongle authentication process module to advance carrying out decentralized finance with controls over access to price discovery and analytics data streamed to and from a remote hybrid paradigm price discovery database (HPPDD). The method may further include using an electronic, self-custodial wallet configured to store operations pertaining to the electronic, self-custodial wallet carried out by at least one of human traders, BOT traders, liquidity providers, trade validators, and price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and requisite proof of reserves compilations.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings. FIG. 1 is a high level flowchart of one example of a system in accordance with the present disclosure which uses edge artificial intelligence computing devices to help implement a permissionless peer-to-peer marketplace which enables a decentralized exchange of cryptoasset pairs;

FIG. 2 is a high level flowchart illustrating one example of various operations that may be performed using the system of FIG. 1;

FIG. 3 is a flow diagram which further helps to illustrate how the various subsystems and components of the invention may communicate with other subsystems to provide a high level of autonomous, yet interconnected, functionality.

### DETAILED DESCRIPTION

Example embodiments will now be described more fully with reference to the accompanying drawings.

The various embodiments and methods associated with the present invention posit a system using edge artificial intelligence computing (“EAIC”) devices to power a permissionless peer-to-peer (“P2P”) marketplace facilitating the decentralized exchange (“DEX”) of offsetting long and short spot index cryptoasset pairs, whose market prices are in each case geared to track those of a referenced weighted average benchmark (“WAB”). In addition, in some embodiments the present disclosure may combine microsegmentation with AI and ML to control the streaming of oracles. This can enhance integrity of data streams and provide even further protection of certain specified security interests needing more robust protection against manipulation or corruption of the data streams.

Each network node with an EAIC device incorporates cryptographic protocols synergizing the effects of artificial intelligence (“AI”), machine language (“ML”), and dongle-authentication hardware and software. Such synergy provides multifaceted users of self-directed DEX electronic, self-custodial wallets (e.g., P2P traders, market makers providing liquidity, DEX protocol assigned validators, and price reporting services) with operating, security and regulatory bandwidth needed to automate repetitive tasks, such as those summarized below. This significantly helps to facilitate direct data processing and storage activity on the network's edge, without the need for constantly relying on cloud infrastructure. As a result, the embodiments and methods of the present invention are more efficient, ready and able to satisfy P2P traders increasingly seeking lower latency and higher decentralization:

The various embodiments and methods of the present invention described herein also facilitate receiving and transmitting updated around-the clock reports covering trade prices and advanced predictive analytics data within the confines of a cloud-based Hybrid Paradigm Price Discovery Database (“HPPDD”). The HPPDD can thus be trusted to compile, process and store key order-matching data integral to each traded pair of DEX-listed cryptoasset indexes, their referenced WAB's, and all qualifying physical assets linked thereto. The edge artificial intelligence computing device (“EAICD”) also connects with identity verification gateways ensuring P2P traders' KYC/AML compliance without forsaking user-desired anonymity or otherwise exposing them to malicious intruders.

In operation, the various embodiments and methods of the present invention implement EAIC devices, which may include electronic, self-custodial wallets, smart phones, tablets, personal digital assistants, trading terminals, Internet of Things routers and servers, and emerging “AI PC's”. These elements may coordinate the use of CPU, GPU and NPU chips to optimize speed, productivity, security and efficiency. It will be appreciated that the electronic, self-custodial wallets may be programmed so as to bypass a confirmation stage when a price reference point is automatically reached. This does not require the core software of the electronic, self-custodial wallet to be modified, but rather this may be accomplished by using an external automation layer built with smart contracts. This is an important feature of any decentralized finance system or network.

Spot index cryptoassets of the present invention allow P2P traders to access market exposures without making direct investments in physical assets, asset baskets or exchange traded derivatives (“ETD's”). The systems and methods of the present invention enable exchanging offsetting index positions-also known as pairs trading-which is a process using algorithms to calculate the respective long and short fractionalized ownership units serving to equalize the extended market values desired for trading. Each WAB referenced herein is essentially a counterpart index. This is because it is linked to a specified set of fungible-yet-varying assets, thus qualifying for physically-settled purchases and sales executed separately over cloud-based over-the-counter and permissioned centralized ETD platforms.

It is especially valuable that the various embodiments and methods of the present invention employ AI and ML, including but not limited to those synergistic with open-source digital twins technology, to help incorporate dynamic encryption systems. These systems can be automatically updated to guarantee robust protection, achievable via algorithms analyzing vast amounts of data in real time. This makes these types of systems and their attendant subsystems adaptable, intelligent and more able to learn, to evolve and to identify suspicious activities before they escalate into security breaches. Adding AI and ML to dongle authentication hardware and software achieves multiple benefits: (a) to regulate identity and access management, and (b) to detect, and even predict, anomalous behavior threatening security.

Hybrid Paradigm, a term cited in U.S. Pat. No. 11,403,655, the teachings of which are hereby incorporated by reference into the present disclosure, refers to computer implemented systems and methods merging the effects of multiple price discovery databases. The multiple price discovery databases are aimed at optimizing the cumulative liquidity of each and all WAB qualified physical assets dealt globally over affiliated networks, subnetworks, and trading platforms. The various embodiments and methods of the present invention aim to enhance those efforts further by inserting the accretive effects of cross liquidity derived from decentralized P2P marketplaces.

This invention mitigates BOP risks by combining security taking place at affiliated HPPDD (used for market price discovery and related analytics data) with user-controls at the EAICD level, described as follows: (i) all EAICD users must be authenticated HPPDD subscribers to access and connect with its data feeds; (ii) all electronic, self-custodial wallets employed for DEX transactions, be they internal (i.e., a component of the user's EAICD) or external (i.e., connected to EAICD via authorized dongle), must be disconnected from the internet unless switched on by the EAICD, a process designed to thwart malicious intrusions; and (iii) once the user's EAICD indicates it has received the requisite off-chain HPPDD feed and is ready to transact, the electronic, self-custodial wallet is authorized to connect with the internet, where it can interact with on-chain smart contracts formulated with specifications needed to effectuate desired DEX transactions.

Matching the orders of P2P traders takes place by integrating dual processes uniquely enabling authorized users to access off-chain HPPDD information while also following applicable on-chain DEX protocols.

DEX protocols regulate the generation and distribution of cryptoassets so that authorized user activity (cited above) can be transparent permissionless and automated, when and as needed, without the expensive friction of intermediaries and counterparty risks prevalent with centralized and permissioned exchange platforms.

DEX protocols also regulate the selection and conduct of entities authorized to (a) validate trades resulting from the execution of order matching processes; and (b) employ distributed consensus mechanisms, including but not limited to open-source solutions employing directed acyclic graph data structures, that will safeguard validated blocks of transactions, which in this case can use Al and ML to consume less time and expense than legacy Proof-of-Work and Proof-of-Stake types known to create network bottlenecks which, if left unchecked, will stunt high-growth trajectories expected for the field of DeFi.

The convergence of Al and DEX's envisaged by the disclosures of this invention will transform the crypto trading landscape by enhancing efficiency, security and user experience.

Referring now to FIG. 1, there is shown one example of a system 100 in accordance with one embodiment of the present disclosure. The system 100 in this example may include at least one EAICD 102, a computer controlled centralized crypto exchange (“CEX”) 112, a computer controlled peer-to-peer (“P2P”) Decentralized Exchange Marketplace (“EX marketplace”) 124, and a cloud based database of compliance regulations 140. One or more of these subsystems may be in communication with one or more edge based computing devices 134 (each with an associated dongle 134a). The edge based computing devices 134 facilitate a reporting service for the computer controlled CEX 112. Edge based computing device 134 includes an artificial intelligence (AI) module 134b, a machine learning (ML) module 134c and a dongle authentication processes module 134d.

It will be appreciated that, in the field of the present disclosure, the term “computerized decentralized exchange”—aka “DEX”, may be considered as a somewhat redundant description for modern P2P crypto trading. A DEX inherently implies a number of independent, processor-driven or computerized P2P systems, and such systems typically use blockchain technology to facilitate direct, trustless trades through automated software known as “smart contracts”. So it may be understood that the reference to “computer controlled” P2P DEX marketplace 124 more broadly encompasses any automated, P2P decentralized exchange which is enabled by devices or subsystems which make use of smart contracts. It will also be appreciated that DEX's and P2P networks are software-based protocols running on computer networks (blockchains) that are implicit on any modern digital exchange. All trades are executed automatically and transparently on the blockchain—i.e., using smart contracts and algorithms like automated market makers (“AMM's”) to match orders and execute trades. The DEX provides the framework (i.e., the exchange), driven by processor or computer driven subsystems, that facilitates this P2P activity.

It will also be appreciated while a P2P exchange marketplace is facilitated by processors or computers, they are not controlled by a central one (like in the case of a crypto CEX). It will therefore be appreciated that the P2P marketplace is decentralized, and thus relying on networks of computers to automate and secure transactions between users without a single intermediary.

One or more additional edge based AI computing devices 136, each with a dongle 136a, may be present for facilitating cloud-based reporting service for a Hybrid Paradigm Price Discovery Database (“HPPDD”). The HPPDD may be shared with traders and validators using the system 100. The edge based computing device 136 similarly includes an AI module 136b, a ML module 136c and a dongle authentication processes module 136d. In addition, one or more remote spot crypto asset index tracking weighted average benchmark prices (“SCAITWABP”) traders 138 using dongle-authenticated edge AI computing devices may communicate with the computer controlled P2P exchange marketplace 124. Finally, a cloud-based database of compliance-based regulations for compliance with KYC, AML and Proof of Reserves regulators 140 may be provided which is in communication with the EAICD 102. The EAICD 102 may be in bidirectional communication with both of the computer controlled CEX 112 and the processor or computer driven P2P DEX marketplace 124.

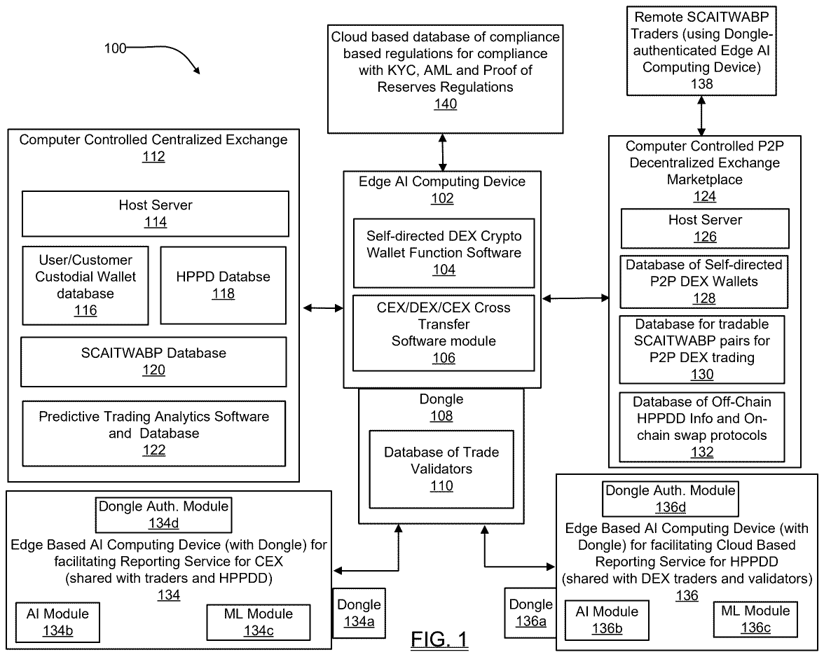

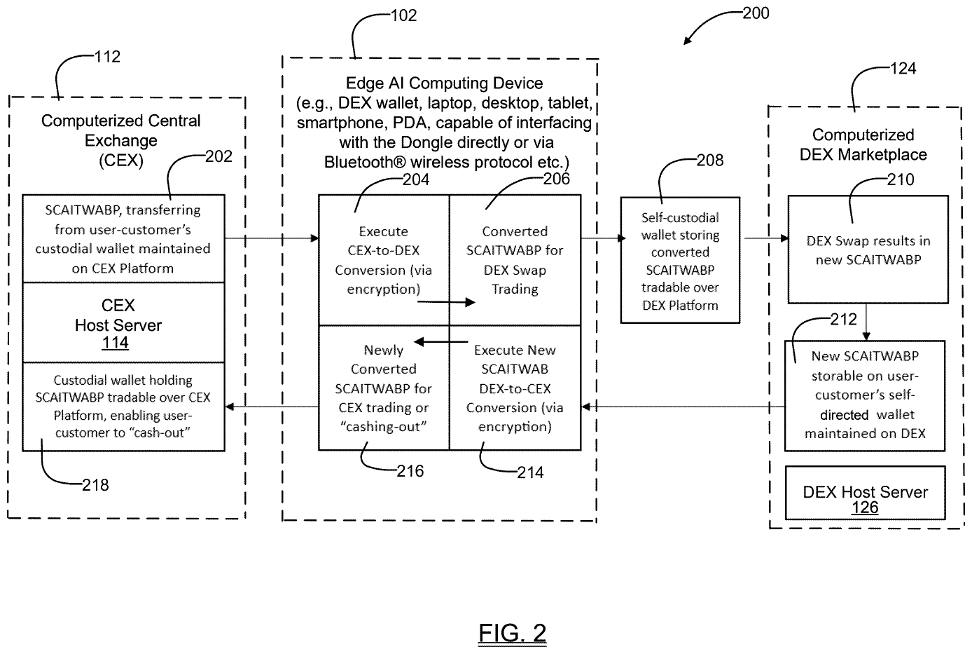

Referring to FIG. 2, a diagram 200 is shown to help illustrate how the various subsystems shown in FIG. 1 may communicate with one another when facilitating decentralized exchanges of spot index cryptoassets. The EAICD 102 may obtain a SCAITWABP from the user-customer's custodial wallet, which is maintained on the computerized CEX 112, as indicated at operation 202. The EAICD 102 may execute a CEX-to-DEX conversion (via encryption), as indicated at operation 204, using a suitable stored program or software module 102a. A converted SCAITWABP results, as indicated at operation 206, which may be used for DEX swap trading. The converted SCAITWABP is transmitted to an electronic, self custodial wallet storing converted SCAITWABP, which is tradable over the DEX marketplace 124, as indicated at operation 208. The resulting DEX swap results in a new SCAITWABP which is received by the computerized DEX marketplace 124, as indicated at operation 210. The new SCAITWABP is storable (and in this example stored) on the user-customer's electronic, self-directed (self-custodial) wallet, as indicated at operation 212. The user-customer's electronic, self-directed (self-custodial) wallet is maintained on the computerized DEX marketplace 124.

With continuing reference to FIG. 2, the new SCAITWABP created and stored at operation 212 may then be transmitted to an EAICD 102 for DEX-to-CEX conversion, as indicated at operation 214. At operation 216 the newly converted SCAITWABP for CEX trading is transmitted out to the CEX 111 and then stored in the user-customer's CEX custodial wallet, as indicated at operation 218.

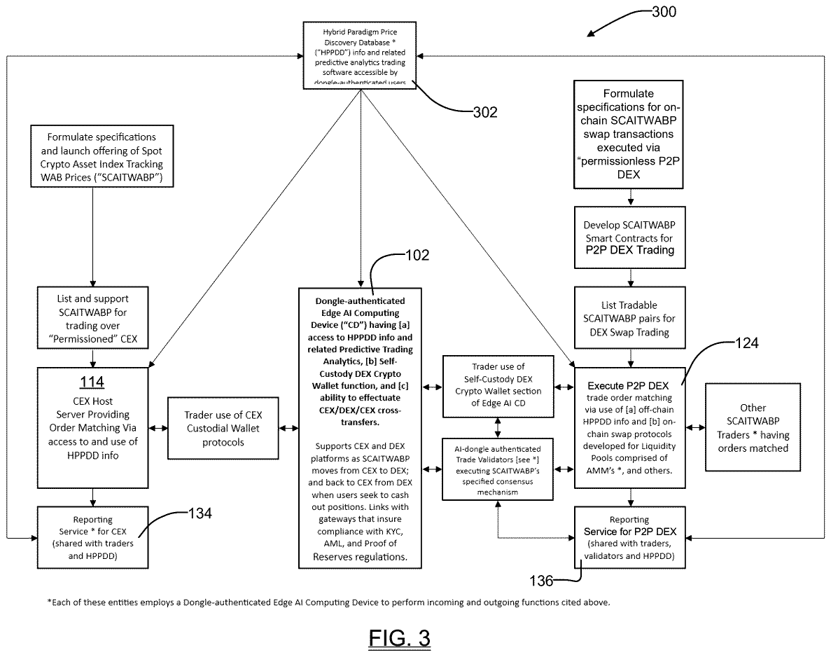

FIG. 3 shows another diagram 300 showing the various subsystems described above may communicate with one another to enable swaps between the EAICD 102, the CEX 112 and the computerized DEX 124. The data, predictive analytics and information stored in the HPPDD is accessible directly by the EAICD 102, the report service for CEX 134, and the reporting service for the P2P DEX 136.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed. ” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit. ” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SOL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A system comprising:
a plurality of edge artificial intelligence (AI) computing devices (EAICDs) for powering peer-to-peer (P2P) marketplaces which facilitates processor or computer driven decentralized exchanges (DEX) of spot index cryptoasset pairs whose values track market prices and algorithm-driven performance analytics of referenced weighted average benchmark (WAB) sets of tradable assets, whereby each one of the tradable assets specified in the WAB set qualifies for transactions physically settled over counterpart marketplaces;
a plurality of dongles, each one of said plurality of dongles being independently operably associated with a specific one of said EAICDs;
wherein each one of said plurality of EAICDs includes:
an artificial intelligence (AI) module;
a machine learning (ML) module;
dongle authentication process modules to advance carrying out decentralized finance with controls over:
access to price discovery and analytics data streamed to and from a remote hybrid paradigm price discovery database (HPPDD); and
an electronic self-custodial wallet configured to store operations pertaining to the electronic, self-custodial wallet carried out by at least one of human traders, BOT traders, liquidity providers, trade validators, price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and requisite proof of reserves compilations.

2. The system of claim 1, wherein the EAICDs includes at least one of:
the electronic, self-custodial wallets,
smart phones,
tablets,
personal digital assistants,
trading terminals,
Internet of Things routers and servers, and
emerging AI Personal Computers implemented to coordinate the use of CPU, GPU, and NPU chips to optimize speed, productivity, security and efficiency.

3. The system of claim 1, wherein both AI and ML are employed by the EAICDs to incorporate and automatically update dynamic encryption systems aimed at achieving robust protection via the use of algorithms analyzing vast amounts of data in real time to be more adaptable, intelligent, and able to learn, evolve and identify suspicious activities before they escalate into security breaches.

4. The system of claim 1, wherein AI and ML processes are provided in dongle authentication hardware and software included in the dongle authentication modules, including authentication tokens built on top of an attendant blockchain, thereby employing unique digital code generating and verifying AI algorithms to regulate identity and access management, plus detect, and even predict, anomalous behavior threatening security.

5. The system of claim 4, wherein AI and ML used by the EAICDs are synergistic with open-source digital twins technology.

6. The system of claim 1, wherein the HPPDD executes computer processes merging the effects of:
remote cloud-based price discovery database servers aimed at optimizing the cumulative liquidity of each and all WAB-qualified physical assets dealt globally over affiliated networks, subnetworks and trading platforms; and
accretive cross-liquidity derived from decentralized P2P marketplaces dealing in spot index cryptoasset pairs.

7. The server of claim 6, wherein the HPPDD employs a server connected to a network, with said server comprising a processor and memory storing instructions used for spot cryptoasset indexes tracking weighted average benchmark prices (SCAITWABP) referencing attendant spot indexes listed for P2P DEX pair trading in real-time, with data for both the short and long sides of the cryptoasset pair trade coming from the same affiliated HPPDD.

8. The system of claim 1, wherein risks attendant to Blockchain Oracle problems (BOP) are mitigated by combining security taking place at affiliated HPPDD in the cloud, which are used for market price discovery and related analytics data, with user-controls at the EAICD level, described as follows:
all users of the EAICD must be HPPDD subscribers authenticated to access and connect with its streaming data feeds;
all of the electronic, self-custodial wallets employed for DEX transactions, whether internal (i.e., a component of the user's EAICD) or external (i.e., connected to EAICD via authorized dongle) must be disconnected from the internet unless switched on by the EAICD; and
once the EAICD indicates it has received a requisite off-chain HPPDD feed and is ready to transact, the electronic, self-custodial wallet is authorized to connect with the internet for interaction with on-chain smart contracts in conformance with instructions created to effectuate desired DEX transactions.

9. The systems of claim 1, wherein the matching of P2P trader orders involves the integration of dual processes uniquely enabling authorized users to access off-chain HPPDD information while applying on-chain DEX control protocols that regulate:
generation and distribution of cryptoassets so that authorized user activity can be transparent, permissionless and automated, when and as needed, without the expensive friction of intermediaries and counterparty risks prevalent with centralized exchange (CEX) platforms operating over permissioned networks;
selection and conduct of entities authorized to validate trades resulting from the execution of order matching processes;
use of distributed consensus mechanisms developed to safeguard validated blocks of transactions, which in this case may benefit by applying AI, ML and open-source solutions with directed acyclic graph data structures to consume less time and expense than legacy Proof-of-Work and Proof-of-Stake types known to create network bottlenecks which, if left unchecked, will stunt high-growth trajectories expected for the field of DeFi.

10. The system of claim 1, wherein the EAICD is configured to:
purchase an online CEX-listed SCAITWABP where it can be maintained by a CEX custodial wallet;
execute a CEX-to-DEX conversion (via encryption) using a suitable stored program or software module;
transfer the converted SCAITWABP to a user-customer's electronic, self-custodial wallet where it can be engaged in direct trading over the computerized DEX marketplace, and ultimately swapped for another, new SCAITWABP acquired from the computerized DEX marketplace; and
execute a DEX-to-CEX conversion, via encryption, to facilitate the new SCAITWABP's transfer to a custodial wallet at the CEX where it is maintained for future CEX trading online, including sale(s) of the new SCAITWABP for cash.

11. The system of claim 1, wherein a native token created for a specific blockchain network created by the system serves a utility role within an ecosystem created by the system to pay transaction fees, participate in governance functions and otherwise run attendant DEX operations, without any prior permission being required, through smart contracts built on top of the specific blockchain network.

12. The system of claim 1, wherein the system further includes and combines microsegmentation with AI and ML to control the streaming of oracles, which can enhance integrity of data streams and provide even further protection of certain specified security interests needing more robust protection against manipulation or corruption of the data streams.

13. A system comprising:
a plurality of edge artificial intelligence computing devices (EAICDs) for powering peer-to-peer (P2P) marketplaces which facilitates processor or computer driven decentralized exchanges (DEX) of spot index cryptoasset pairs whose values track market prices and algorithm-driven performance analytics of referenced weighted average benchmark (WAB) sets of tradable assets, whereby each one of the tradable assets specified in the WAB set qualifies for transactions physically settled over counterpart marketplaces;
a plurality of dongles, each one of said plurality of dongles being independently operably associated with a specific one of said EAICDs;
wherein each one of said plurality of EAICDs includes:
an artificial intelligence (AI) module;
a machine learning (ML) module;
dongle authentication process modules to enable and/or advance carrying out decentralized finance with controls over at least one of access to price discovery or analytics data streamed to and from a remote hybrid paradigm price discovery database (HPPDD); and
the system further including an electronic, self-custodial wallet configured to store operations pertaining to the electronic, self-custodial wallet carried out by at least one of human traders, BOT traders, liquidity providers, trade validators, price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and requisite proof of reserves compilations; and
the EAICDs further being configured to incorporate and automatically update dynamic encryption systems aimed at achieving robust protection via the use of algorithms analyzing vast amounts of data in real time to be more adaptable, intelligent, and able to learn, evolve and identify suspicious activities before said suspicious activity escalates into a security breach.

14. The system of claim 13, wherein the EAICDs are configured to automatically update dynamic encryption systems aimed at achieving robust protection via the use of stored algorithms analyzing data in real time to be even more adaptable, intelligent, and able to learn, evolve and identify suspicious activities before said suspicious activities escalate into security breaches.

15. The system of claim 13, wherein:
the HPPDD executes computer processes merging the effects of:
remote cloud-based price discovery database servers aimed at optimizing the cumulative liquidity of each and all WAB-qualified physical assets dealt globally over affiliated networks, subnetworks and trading platforms; and
accretive cross-liquidity derived from decentralized P2P marketplaces dealing in spot index cryptoasset pairs.

16. The system of claim 13, wherein:
the HPPDD employs a server connected to a network, with said server comprising: a processor; and
a memory storing instructions used for spot cryptoasset indexes tracking weighted average benchmark prices (SCAITWABP) referencing attendant spot indexes listed for P2P DEX pair trading in real-time, with data for both the short and long sides of the cryptoasset pair trade coming from the same affiliated HPPDD.

17. The system of claim 13, wherein:
risks attendant to Blockchain Oracle problems (BOP) are mitigated by combining security taking place at affiliated HPPDD in the cloud, which are used for market price discovery and related analytics data, with user-controls at the EAICD level, described as follows:
all users of the EAICD are required to be HPPDD subscribers authenticated to access and connect with its streaming data feeds;
all of the electronic, self-custodial wallets employed for DEX transactions, whether internal (i.e., a component of the user's EAICD) or external (i.e., connected to EAICD via authorized dongle) must be disconnected from the internet unless switched on by the EAICD; and
once the EAICD indicates it has received a requisite off-chain HPPDD feed and is ready to transact, the electronic, self-custodial wallet is authorized to connect with the internet for interaction with on-chain smart contracts in conformance with instructions created to effectuate desired DEX transactions.

18. The system of claim 13, wherein matching of P2P trader orders involves an integration of dual processes uniquely enabling authorized users to access off-chain HPPDD information while applying on-chain DEX control protocols that regulate:
generation and distribution of cryptoassets so that authorized user activity can be transparent, permissionless and automated, when and as needed, without the expensive friction of intermediaries and counterparty risks prevalent with centralized exchange (CEX) platforms operating over permissioned networks;
selection and conduct of entities authorized to validate trades resulting from the execution of order matching processes; and
use of distributed consensus mechanisms developed to safeguard validated blocks of transactions, which in this case may benefit by applying AI, ML and open-source solutions with directed acyclic graph data structures to consume less time and expense than legacy Proof-of-Work and Proof-of-Stake types known to create network bottlenecks which, if left unchecked, will stunt high-growth trajectories expected for the field of DeFi.

19. A method for managing and carrying out trading and swaps of spot cryptoasset index tracking weighted asset benchmark prices (SCAITWABPs), wirelessly between remotely located parties or entities, the method comprising:
using a plurality of edge artificial intelligence (AI) computing devices (EAICDs) for powering peer-to-peer (P2P) marketplaces to facilitate computerized decentralized exchanges (DEX) of spot index cryptoasset pairs whose values track market prices and algorithm-driven performance analytics of referenced weighted average benchmark (WAB) sets of tradable assets, whereby each one of the tradable assets specified in the WAB set qualifies for transactions physically settled over counterpart marketplaces;
using a plurality of dongles, each one of said plurality of dongles being independently operably associated with a specific one of said EAICDs;
wherein each one of said plurality of EAICDs includes:
an artificial intelligence (AI) module;
a machine learning (ML) module;
dongle authentication process modules to advance carrying out decentralized finance with controls over:
access to price discovery and analytics data streamed to and from a remote hybrid paradigm price discovery database (HPPDD); and
using an electronic, self-custodial wallet configured to store operations pertaining to the electronic, self-custodial wallet carried out by at least one of human traders, BOT traders, liquidity providers, trade validators, price reporting services; and links to trade identity verification gateways insuring KYC/AML compliance; order matching and execution integrating off-chain HPPDD with on-chain DEX protocols; consensus mechanisms consuming less time and expense than legacy proof-of-work and proof-of-stake types; and requisite proof of reserves compilations.
